(19) United States
(12) Patent Application Publication
(10) Pub. No.: US 2015/0090539 A1
(43) Pub. Date: Apr. 2, 2015

(54) Brake Mechanism for Grocery and other User-Propelled Carts

(71) Applicant: Jonathan Degnan, Knoxville, TN (US)

(72) Inventor: Jonathan Degnan, Knoxville, TN (US)

(21) Appl. No.: 14/498,167

(22) Filed: Sep. 26, 2014

Related U.S. Application Data
(60) Provisional application No. 61/885,815, filed on Oct. 2, 2013.

(51) Int. Cl. B62B 5/04

(52) U.S. Cl. CPC B62B 5/0433; B62B 5/0485; B62B 5/049
USPC 188/19

(57) ABSTRACT

An brake mechanism adapted to be secured to the rear wheels of a user-propelled cart, such as a grocery cart, includes a chock member for chocking wheel when brake mechanism is in the deployed, or braking position. Brake mechanism further includes a chock support member for rotatably securing the chock member to the wheel attachment members. In this regard, the chock support member rotatably secures chock member to wheel attachment member such that chock member can be selectively rotated, by a user of the cart, from an upward, or non-braking, position to a deployed, or braking position.

### CROSS-REFERENCE TO RELATED APPLICATIONS

This application claims the benefit of U.S. Provisional Patent Application Ser. No. 61/885,815, filed on Oct. 2, 2013, the disclosure of which is incorporated by reference herein in its entirety.

### STATEMENT REGARDING FEDERALLY SPONSORED RESEARCH OR DEVELOPMENT

Not Applicable

### BACKGROUND OF THE INVENTION

1. Field of Invention

This invention pertains to user-propelled carts, such as grocery carts and luggage carts. More particularly, this invention pertains to a user-actuated braking mechanism to prevent the user-propelled cart from rolling backwards into, and potentially injuring, the user.

2. Description of the Related Art

User-propelled carts, particularly grocery carts and the like have long been known in the art. And, there have been many braking mechanisms taught in the art for arresting unwanted or undesired motion in such carts. In this regard, it will be appreciated by those skilled in the art that while the rolling surface for such carts is generally nearly perfectly level within a grocery store, or within an airport, or hotel, where such carts are frequently used, the parking lots adjoining such places are often not level; many have an imperceptible, or sometimes a clearly perceptible, incline. This causes such carts to be at risk when the user needs to unload groceries from such cart or needs to load or unload luggage from the cart while in a parking lot. This creates a risk of a loaded cart rolling into the user. Further, and especially with regard to grocery carts, such carts are frequently left unattended. This creates a risk of the cart rolling into a parked car or perhaps rolling into an unobservant pedestrian within the parking lot.

Typical of the known braking mechanisms for grocery carts and the like are the devices taught and described in the following U.S. Patents:

U.S. Pat. No. 4,840,388, issued to Doughty on Jun. 20, 1989, teaches and discloses an automatic braking apparatus for inclusion with a user-propelled grocery cart. Doughty's braking apparatus includes a handle portion that is user actuated. Doughty's braking mechanism includes a spring mechanism for biasing the braking mechanism toward the braked position.

U.S. Pat. No. 5,090,517, issued to Doughty on Feb. 25, 1992, teaches and discloses a handle actuated apparatus for automatically braking a user-propelled cart which includes a braking mechanism shiftable between braked and released positions interconnected to a shiftable handle actuated by the user by pressing the handle forward.

U.S. Pat. No. 6,123,343, issued to Nolting et al. on Sep. 26, 2000, teaches and discloses a braking mechanism that is selectively operable between a braking position and a non-braking position. Nolting's device includes a tubular handle assembly that is grasped by the user. Nolting's braking device is spring biased toward the braking position and the user engages the handle assembly to release the brake. U.S. Pat. No. 6,481,540, issued to Nolting et al. on Nov. 19, 2002, teaches and discloses a cart brake release handle having a core that is shiftably coupled the cart's handle mounting bracket.

U.S. Pat. No. 6,533,297, issued to Saccani on Mar. 18, 2003, teaches and discloses an improved shopping cart with a floating basket that is moveable in response to downward or lateral forces. Saccani's improved cart also discloses an automatic braking assembly that is released from the locked position by biasing the braking handle towards the cart handle.

U.S. Pat. No. 7,396,026, issued to Munson on Jul. 8, 2008, teaches and discloses a cable operated shopping cart brake apparatus that is handle actuated by a brake handle proximate the cart handle.

In general, these known braking mechanisms for grocery carts involve the engagement of the handle with the wheels, which makes them complicated and difficult to install and operate. It would likely be costly for the retailers or other businesses to install these brake mechanisms onto their already in use carts if the brake systems were not already integrated into the structure of those carts.

Thus, in light of the above, there is a need for a simple to use braking device that can be easily installed onto grocery carts and other user-propelled carts that requires minimal structural alteration to the carts.

### BRIEF SUMMARY OF THE INVENTION

Described herein is a brake device that can be installed onto grocery carts and other user-propelled carts and provide restriction to the movement of the wheel portion of the cart when the braking mechanism is deployed. According to one embodiment of the present invention, the brake device is adapted to be secured to the wheel assembly of a user-propelled cart, said device includes a chock member for chocking the wheel when the brake mechanism is rotated, by the user of the cart, into the deployed, or braking position.

In addition, the brake mechanism of the present invention further includes a chock support member for rotatably securing the chock member to the wheel attachment members of the grocery cart. The rotatable attachment of the chock member to the wheel attachment member is such that chock member can be selectively rotated from an upward, or non-braking, position to a deployed, or braking position.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a side elevation view of one example embodiment of a user-propelled cart constructed in accordance with several features of present invention;

FIG. 2 is a perspective view of a PRIOR ART wheel assembly for a user-propelled cart, such as a grocery cart;

FIG. 3A is a rear elevation view of a grocery cart wheel assembly having the brake mechanism of the present invention in the upward, or non-braking, position;

FIG. 3B is a rear elevation view of a grocery cart wheel assembly having the brake mechanism of the present invention in the deployed, or braking, position;

FIG. 4A is a partial side elevation view of a grocery cart with the braking mechanism of the present invention in the non-braking or non-deployed position;

FIG. 4B is a partial side elevation view of a grocery cart with the braking mechanism of the present invention in the braking or deployed position;

FIG. 5 is partial rear elevation view of a grocery cart with an alternate embodiment of the braking mechanism of the present invention in the upward, or non-braking position.

### DETAILED DESCRIPTION OF THE INVENTION

In accordance with several features of the present invention, various exemplary embodiments of a braking mechanism for a user-propelled cart, such as a grocery cart or a luggage cart are disclosed herein and in the accompanying figures. In several embodiments, the braking mechanism provides a chock member adapted to be secured to a wheel assembly of a user-propelled car in such a way that a user may deploy the braking mechanism by moving the chock member from non-braking position to the braking position.

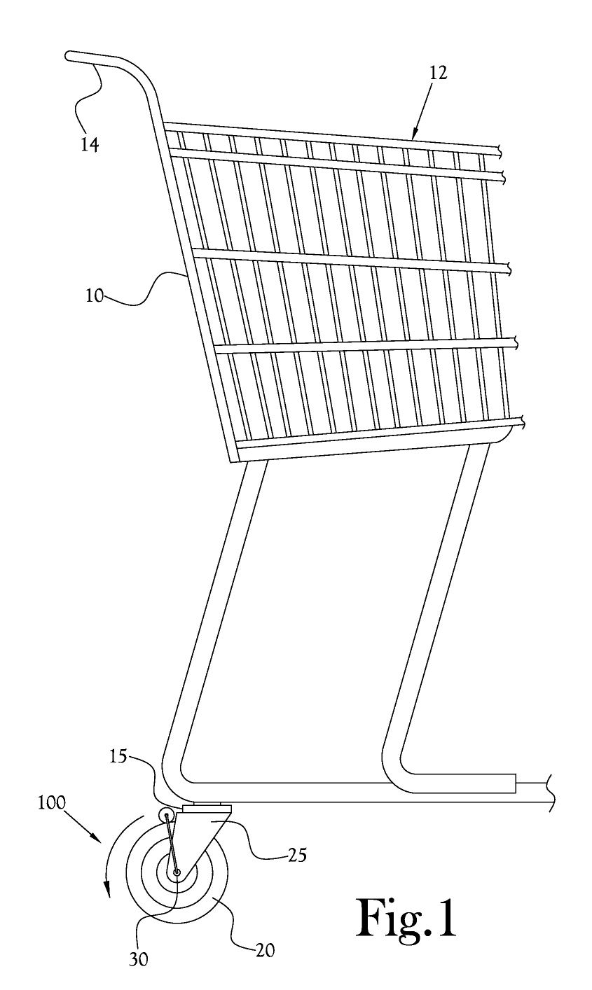

One embodiment of the braking mechanism implemented in accordance with several features of the present invention is illustrated in FIG. 1 and FIGS. 3A-4B. As shown in FIG. 1, the braking mechanism provided by the present invention generally may be installed onto a typical user-propelled cart.

With initial reference to FIG. 1, the present invention relates to a brake mechanism 100 adapted to be secured to the wheel assembly 15 of a user-propelled cart 10. In use, the brake mechanism 100 is engaged to prevent the cart 10 from rolling backward. The cart 10 illustrated in FIG. 1 is configured for transporting material, such as luggage, grocery, or other goods. The cart 10 includes a frame generally having a loading portion 12, an operator portion that comprises a handle 14 and a wheel assembly that comprises at least one rear wheel assembly 15. Those skilled in the art will recognize that there are many types and configurations of user-propelled carts. Herein, with respect to the present invention, a typical grocery cart configuration is discussed and illustrated, in the figures. However, no limitation is intended, it being understood by those skilled in the art that the teachings of the present invention are suited for many sorts of user-propelled carts, such as, without limitation, grocery carts, luggage carts, box carts, etc. without departing from the spirit and scope of the present invention. More specifically, the braking and non-braking operation of the cart in the present invention involves the engagement of the brake mechanism 100 with the wheel assembly 15 of the cart 10. Shown in FIG. 1, the brake mechanism 100 involves an addition of a chock member 120 to the wheel assembly 15 and then deploying the chock member 120 from an upward, non-braking position downward to a braking position as indicated by the arrow 110.

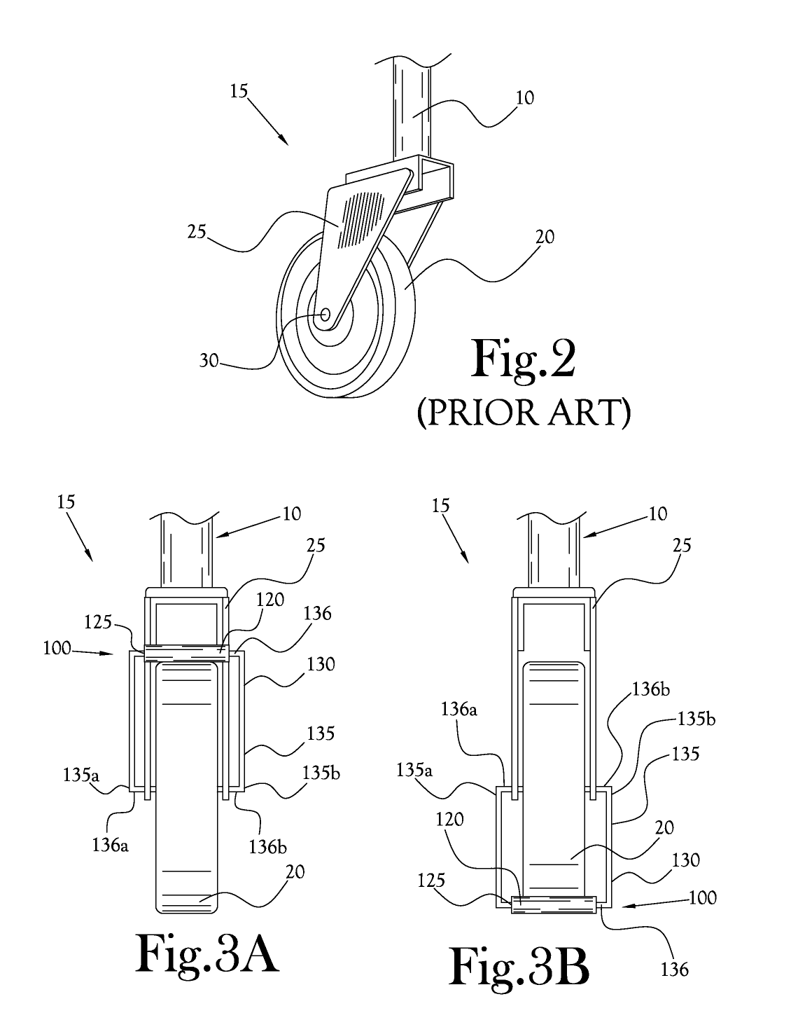

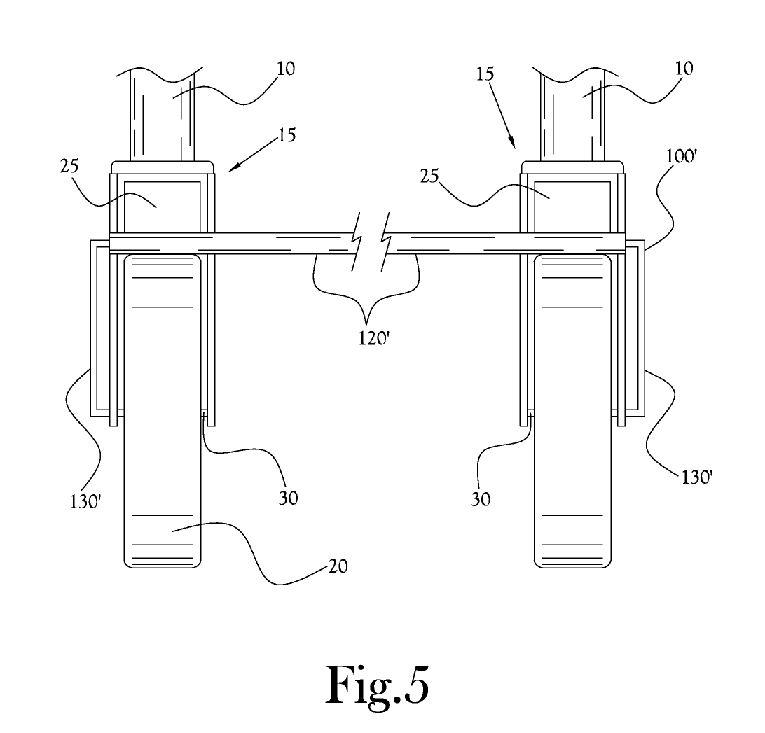

FIG. 2 illustrates a generic, rear wheel assembly 15 as might be found on a user-propelled cart 10, such as a grocery cart or a luggage cart. It will be recognized that grocery cart 10 includes four wheel assemblies 15 only one of which is illustrated in FIGS. 1-4 with FIG. 5 illustrating each of the two rear wheel assemblies 15. Wheel assembly 15 further includes wheel 20, wheel attachment members 25, and wheel axle 30.

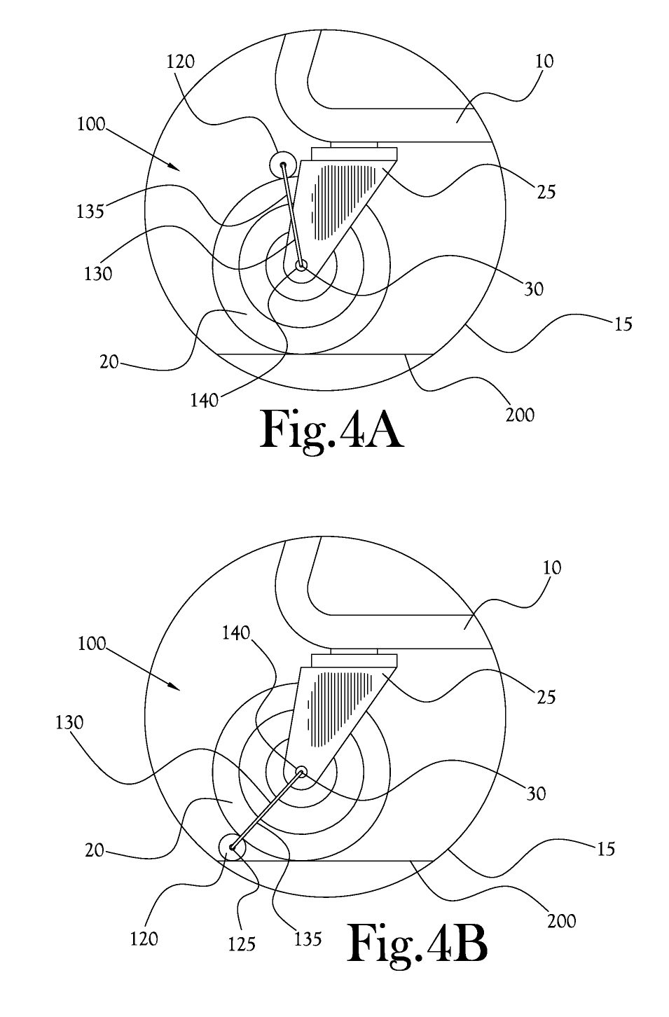

One embodiment of the braking mechanism and device for a user-propelled cart in accordance with several features of the present invention is illustrated in FIGS. 3A/3B and FIGS. 4A/4B. In the illustrated embodiments, the brake mechanism 100 functions to provide braking action to the wheel 20. With reference to FIGS. 3A and 3B, the brake mechanism 100 includes a chock member 120 for chocking wheel 20 when brake mechanism 100 is in the deployed, or braking position. For example, as shown in the figures, the chock member 120 is generally defined by a rod like cylindrical shape. The cylindrical shape of the chock member 120 allows the uninterrupted movement of the wheel 20 when the brake mechanism 100 is at the non-braking upward position. However, it will be recognized that other shapes, such as for example cylindrical or semi-cylindrical, spherical, and the like, may be used without departing from the spirit and scope of the present invention as long as the shape of the chock member 120 when deployed allows for restraining further movement of the wheel 20. In addition, the chock member 120 may be in a solid construction or define at least one opening to allow the insertion of other support members to the wheel assembly 15. The chock member 120 may be made of rubber or other similar material that can provide sufficient friction to restrain the wheel's movement but not damage the surface of the wheel 20.

In one embodiment, the brake mechanism 100 in accordance with the present invention further includes a chock support member 130 for rotatably securing the chock member 120 to the wheel attachment members such that chock member 120 can be selectively rotated from an upward, or non-braking, position, illustrated in FIG. 3A and FIG. 4A to a deployed, or braking position illustrated in FIG. 3B and FIG. 4B. For example, as shown in FIGS. 3A and 3B, the chock support member 130 is secured to wheel attachment member 25 proximate to and coaxial with wheel axle 30, the length of chock support member 130 can be selected so as to allow attachment to any portion of the wheel attachment member 25 proximate the wheel 20. The chock support member 130 may be comprised of any suitable material, including metal or plastic, having sufficient resiliency to enable a person installing the device to forcefully attach the device to wheel assembly 15 and offer support for the chock member 120.

More particularly, the chock support member 130 may include a vertical component 135 that connects to a horizontal component 136. The ends 135a, 135b of the vertical component 135 each connects to the ends 136a, 136b of the horizontal component 136. The horizontal component 136 may also structurally engage with the chock member 120. The vertical and the horizontal configuration of the chock support member 130 in connection with the chock member 120 may form a rectangular bracket-like shape. However, it will be recognized that other structural frame, may be used without departing from the spirit and scope of the present invention as long as the shape of the chock member 120 when deployed allows for restraining further movement of the wheel 20.

As mentioned above, the chock member 120 may be in a solid construction or may define an opening that extends through the length of the chock member 120 to allow the insertion of other support members. Depending on the construction of the chock member 120, the chock support member 130 may engage the chock member 120 in various ways. For example, as illustrated in FIGS. 3A and 3B, the horizontal component 136 of the chock support member 130 may be inserted into the opening 125 of the chock member and extend through the length of the chock member 120. Alternately, not demonstrated in the figures, the horizontal component of the chock support member 130 may also be attached or mounted to the chock member 120 at two opposite ends of the chock member 120 using bolts or other securing means. Or alternately, the end of the vertical component of the chock support member 130 may also be attached or mounted to the chock member 120 at two opposite ends of the chock member 120 using bolts or other securing means.

In some embodiments, the chock support member 130 may be configured to couple to the wheel assembly 15 at the wheel axel 30 through a fastener. For example of illustrated in FIGS. 4A and 4B, a fastener is used to securely couple the wheel 20 to the axle 30. The chock member 120, the chock support member 130 and the wheel 20 may each be independently removed and replaced without having to remove or replace the entire brake mechanism 100.

In addition, according to the present invention, the selected length and attachment position for chock support member 130 is selected such that in the deployed, or braking, position, chock member 120 simultaneously engages both wheel 20 and the supporting surface 200 of the ground, floor, parking lot, or whatever surface the shopping cart 10 is resting, or rolling, upon in a tangential manner. The length of chock member 120 and the length of the chock support member 130 may be adjusted to fit a variety of different sized wheels.

In order to prevent unintended rotation, or deployment, of chock member 120, chock support member 130 can be secured to wheel attachment member in a tight frictional fit that resists free rotation, but permits selective rotation by a user. Alternately, chock member 120 could be magnetically secured to the wheel attachment member 25 in the upward position. Or, any variety of known spring clamps (not shown) could be utilized to secure chock member 120 in the upward, non-braking, position. The chock member 120 frictionally engages with the wheels 20 to slow or stop the shopping cart 10 when the user deploy the brake mechanism by pulling down the chock member to this brake position.

In use, the operator may deploy the brake mechanism 100 by pulling the chock member 120 downward until it touches the ground 200. FIGS. 4A and 4B show the brake mechanism 100 in engagement with the ground surface 200. The operator may restrain the movement of the cart when the chock member 120 has brought fully to the ground surface 200. The operator may lift the chock member 120 upward to return the brake mechanism 100 to the non-braking position.

In the embodiment illustrated in FIGS. 2-4B, a brake mechanism 100 is provided for at least one, and preferably both of the rear wheel assemblies 15. In FIG. 5, an alternate embodiment brake mechanism 100′ is illustrated. In this embodiment the chock member 120′ has a length selected to span the distance between each of the rear wheel assemblies 15. Each end of the chock member 120′ is secured to the proximate wheel attachment member 25 by means of a chock support member 130′.

The present brake mechanism 100 does not interfere with normal use of the existing shopping carts, and is adapted to be readily retrofitted to existing shopping carts. The chock member 120 and the chock support member 130 can be configured and arranged for easy replacement and maintenance. For example, the mechanism 100 is detachable at the attachment points, such as the axle of the wheel 30 or the points 125 where chock support member 130 engages with the chock member 120.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. In a wheel assembly for a user-propelled cart, said wheel assembly including at least a wheel attachment member and a wheel member, a brake mechanism for selectively preventing rolling of the user-propelled cart, said brake mechanism comprising:
a chock member mounted proximate the wheel member, and
at least one chock support member for rotatably securing said chock member to the wheel attachment member, such that said chock member can be selectively, and rotatably, moved from an upward non-braking position to a deployed braking position, wherein in said deployed braking position, said chock member tangentially engages the wheel, whereby rotation of the wheel is impeded.

2. The brake mechanism of claim 1 wherein said at least one chock member is secured to the wheel attachment member in a tight, frictional fit such that unintended rotation of said brake mechanism is impeded.

3. The brake mechanism of claim 1 wherein the user-propelled cart has two rear wheels disposed from each other by a selected distance, and wherein said at least one chock member has a length selected to engage the two rear wheels.

4. The brake mechanism of claim 1 wherein the user-propelled cart has two rear wheels disposed from each other by a selected distance, said brake mechanism comprising a chock member for chocking each of the wheel members of the user-propelled cart.

5. A brake mechanism adapted to be installed onto a wheel portion of a user-propelled cart that selectively prevents rolling of the user-propelled cart from rolling backward, said device comprising:
a chock member mounted proximate the wheel member, and
a chock support member for rotatably securing said chock member to the wheel attachment member, such that said chock member can be selectively, and rotatably, moved from an upward non-braking position to a deployed braking position, wherein in said deployed braking position, said chock member tangentially engages the wheel, whereby rotation of the wheel is impeded.

6. The brake mechanism of claim 5 wherein said the chock member is substantially cylindrical.

7. The brake mechanism of claim 5, wherein said chock member defines an opening to allow the insertion of said support member.

8. The brake mechanism of claim 5 wherein said chock support member includes a vertical component and a horizontal component that engages with said chock member.

9. The brake mechanism of claim 8 wherein said vertical and said horizontal of said support member in connection with said chock member defines a rectangular bracket-like shape.

10. The brake mechanism of claim 8 wherein said horizontal component of the chock support member is inserted into an opening defined by said chock member and extends through the length of said chock member.

11. The brake mechanism of claim 8 wherein the horizontal component of the chock support member is attached to the chock member at two opposite ends of said chock member.

12. The brake mechanism of claim 8, wherein an end of the vertical component of the chock support member is attached to an end of said chock member.

13. The brake mechanism of claim 5 wherein said chock support member is coupled to said wheel portion of said cart at a wheel axle using a fastener.

14. The brake mechanism of claim 5, wherein said chock member is independently detachable.

15. The brake mechanism of claim 5, wherein said chock support member is independently detachable.

16. The brake mechanism of claim 5, wherein in the deployed position, said chock member simultaneously engages both said wheel and a supporting surface of the ground in a tangential manner.

17. The brake mechanism of claim 5 wherein said chock member is magnetically secured to wheel attachment member in the upward position.

18. The brake mechanism of claim 5 wherein said support chock member is detachable at an axle of said wheel.

19. The brake mechanism of claim 5 wherein said support chock member is detachable at a point where said chock support member engages with the chock member.
